(19) United States
(12) Patent Application Publication
(10) Pub. No.: US 2010/0184923 A1
(43) Pub. Date: Jul. 22, 2010

(54) EPOXY RESIN COMPOSITION

(76) Inventors: Kazuhiko Yoshida, Chiba (JP); Masao Gunji, Chiba (JP); Seigou Takuwa, Chiba (JP)

Correspondence Address: FLYNN THIEL BOUTELL & TANIS, P.C., 2026 RAMBLING ROAD, KALAMAZOO, MI, 49008-1631, US

(21) Appl. No.: 12/452,506

(22) PCT Filed: Jun. 12, 2008
(86) PCT No.: PCT/JP2008/061170

§ 371 Date: Jan. 5, 2010

(30) Foreign Application Priority Data
Jul. 24, 2007 (JP) 2007-191990

(51) Int. Cl. C08G 59/00

(52) U.S. Cl. 525/418

(57) ABSTRACT

An epoxy resin composition comprising, containing a solid epoxy resin (A) whose aromatic ring containing ratio is 5-40% obtained by reacting a polyester compound (b) possessing 1.2-1.8 of carboxylic group with a divalent epoxy resin (a) whose epoxy equivalent is 120-350 g/eq and a crosslinking agent (B) as essential components, and since a cured product obtained by curing said composition is superior in heat resistance, humid resistance and cracking resistance, said composition is useful in a field of electron material such as photo semi conductor sealing material, in particular useful for LED sealing.

### FIELD OF THE INVENTION

The present invention relates to an epoxy resin composition which is excellent in humid resistance, heat resistance, cracking resistance and transparency, and is useful for a resin for coating, for a coating agent, for a printing ink, for a resist ink, for an adherent, for a sealing material of semiconductor, for a molding material, for a casting material and for an electric insulator material, in particular, relates to an epoxy resin composition which is suited for a sealing agent of light emitting diode (hereinafter shortened to LED).

### DESCRIPTION OF THE PRIOR ART

In general, an epoxy resin is widely used in coating field, civil engineering field and electric field because of excellent electric property, adhesive property and heat resistance. Especially, since aromatic epoxy resin such as diglycidylether of bisphenol A, diglycidylether of bisphenol F, phenol novolac epoxy resins or cresol novolac epoxy resins is excellent in water resistance, adhering property, mechanical property, heat resistance, electric insulation property and economical view point, is broadly used by combination with various curing agents. However, these aromatic epoxy resins have a tendency to be deteriorated by ultra violet ray and there is restriction of use in the field where light resistance is required. Recently, photo semiconductor represented by LED is used for various uses for example, indicator, movile, back light source for mobile phone, sensor or parts of car, and predicted to be more widely used for illumination. Most part of these photo semiconductor uses epoxy resin as a sealing resin. Especially, in a case when molded by a transfer molding method, a solid epoxy resin such as BPA epoxy resin which is solid at ordinary temperature or alicyclic backbone epoxy resin are used. However, heat resistance condition required to sealing resin is becoming severe along with improvement for higher brilliant (=high temperature) of LED.

In patent document 1, an epoxy resin composition for electric•electronic material containing hydrogenated epoxy resin obtained by hydrogenation of aromatic epoxy resin is disclosed. In patent document 2, an epoxy resin composition for sealing of photo semiconductor, which applies specific curing accelerator to aromatic or alicyclic epoxy resin, is proposed. In patent document 3, an epoxy resin composition prepared by blending alicyclic epoxy resin by specific ratio and not containing halogen element in a curing accelerator or in other additives, is disclosed. In patent document 4, an epoxy resin composition to be used for sealing of LED containing hydrogenated epoxy resin obtained by hydrogenation of aromatic epoxy resin or epoxy resin obtained by reacting hydrogenation epoxy resin obtained by hydrogenation of aromatic epoxy resin with multivalent carboxylic acid, alicyclic epoxy resin obtained by epoxyrizing cyclic olefin and acid anhydride curing agent or cationic polymerization initiator is proposed. However, for the purpose to improve long term environmental reliability, cracking resistance when heat cycle is loaded, is required. To satisfy these required property, it is necessary that high Tg is consistent with low elastic modulus in rubber sphere, although these two are in tradeoff relationship. And conventional solid transparent epoxy resins do not satisfy these required properties.

Patent Document 1: JP3537119 publication

Patent Document 2: JPA 115-9268 publication

Patent Document 3: JPA H9-213997 publication

Patent Document 4: JPA 2003-277437 publication

### DISCLOSURE OF THE INVENTION

The present invention is carried out considering above mentioned circumstances, and the object of the present invention is to provide an epoxy resin composition which is useful in fields of coating, ink, resist ink, adhesive or electronic materials, especially useful in LED sealing field, characterized being solid at ordinary temperature, having low water absorption rate and excellent in cracking resistance, heat resistance and transparency.

The inventors of the present invention continued investigation to dissolve above mentioned problems of epoxy resin, and accomplished the present invention. That is, by use of an epoxy resin composition comprising, containing an epoxy resin (A) whose aromatic ring containing ratio is 5-40% obtained by reacting a polyester compound (b) possessing 1.2-1.8 of carboxylic group per one molecular with a divalent epoxy resin (a) whose epoxy equivalent is 120-350 g/eq and a crosslinking agent (B) as essential components, and a cured product obtained by curing said epoxy resin composition, above mentioned problems can be dissolved.

### PREFERRED EMBODIMENT OF THE INVENTION

Solid epoxy resin (A) used as the essential component of the epoxy resin composition of the present invention is obtained by reacting polyester compound (b) possessing 1.2-1.8 of carboxylic group with divalent epoxy resin (a) whose epoxy equivalent is 120-350 g/eq, and is obtained by reacting carboxyl group of polyester compound (b) to epoxy group of epoxy resin (a). Aromatic ring containing ratio of obtained solid epoxy resin (A) is 5-40%.

The polyester compound (b) can be obtained by reaction of a divalent carboxylic acid or acid anhydride thereof with a divalent alcohol, and a method for, preparation is not restricted. By reaction 1.2-1.8 mol of divalent carboxylic acid or acid anhydride thereof to 1 mol of divalent alcohol polyester compound possessing 1.2-1.8 of carboxylic group per one molecular can be synthesized. When the number of carboxylic group per one molecular is smaller than 1.2, heat resistance of cured product deteriorates, and when is larger than 1.8, cracking resistance deteriorates.

As divalent carboxylic acid and acid anhydride thereof, which is one component of the polyester compound (b), alicyclic or aromatic multivalent carboxylic acid such as methylhexahydrophthalic acid, hexahydrophthalic acid, methyltetrahydrophthalic acid, tetrahydrophthalic acid, methylnadic acid, phthalic acid, isophthalic acid or terephthalic acid and anhydride thereof can be mentioned, and these compounds can be used alone or can be used by mixing.

As a divalent alcohol, which is another component of the polyester compound (b), aliphatic glycols such as ethylene glycol, propylene glycol, neopentyl glycol or 1,6-hexane diol, alicyclic glycol such as 2,2-bis(4-hydroxycyclohexyl)propane, 1,4cyclohexanedimethanol, bis(4-hydroxycyclohexypmethane, spiroglycol, 2-(5-ethyl-5-hydroxymethyl-1,3-dioxane-2-yl)-2-methylpropane-1-ol can be mentioned.

Epoxy equivalent of a divalent epoxy resin (a) is 120-350 g/eq. Epoxy resin whose epoxy equivalent is less than 120 g/eq is difficult to be synthesized, and when epoxy equivalent exceeds 350 g/eq, heat resistance of cured product deteriorates. As a specific example of a divalent epoxy resin (a), diglycidylether of 2,5-di-tert-butyl-1,4-phenylenebis, diglycidylether of 2,5-dimethyl-1,4-phenylenebis, diglycidylether of 2,2-bis(4-hydroxyphenyl)propane, diglycidylether of bisphenol C, diglycidylether of bisphenol Z, diglycidylether of bisphenolfluorene, diglycidylether of biscresolfluorene or hydride of these compounds can be mentioned. These compounds can be used alone or as a mixture of two or more kinds of these compounds.

It is necessary that at least one selected from the group consisting of epoxy resin (a) and polyester compound (b), which are used in solid epoxy resin (A), to possess an aromatic ring, further, it is necessary to adjust aromatic ring content in the solid epoxy resin (A) to 5-40%. When the aromatic ring content exceeds 40%, color changing resistance to heat deteriorates. Further, in a case that the aromatic ring content is smaller than 5%, heat resistance deteriorates. Desirably aromatic ring content is 10-30%, more desirably 13-25%. The aromatic ring content is calculated by weight % of aromatic ring in the solid epoxy resin (A).

Method for preparation of the solid epoxy resin (A) is not specially restricted, and any public known conventional method can be used. As a typical method for preparation, following method can be mentioned. That is, the solid epoxy resin (A) can be obtained by reacting 0.2-0.9 carboxyl group equivalent ratio, desirably 0.3-0.6 carboxyl group equivalent ratio of polyester compound (b) to 1 equivalent of epoxy group of epoxy resin of epoxy resin (a), under the presence of catalyst at 120-180° C. When the ratio of carboxyl group is smaller than 0.2 equivalent, softening point is law and blocking resistance deteriorates. And when the ratio of carboxyl group is larger than 0.9 equivalent, melt viscosity becomes high and handling at curing process becomes bad.

The solid epoxy resin (A) obtained as above is characterized that epoxy equivalent is 300-1000 g/eq and softening point is 60-120° C., desirably, epoxy equivalent is 400-900 g/eq. When epoxy equivalent is smaller than 300 g/eq, crosslinking density of cured product becomes high and cracking resistance is not sufficient, while, when epoxy equivalent is larger than 1000 g/eq, the cured product inferiors in heat resistance.

In the composition of the present invention, the solid epoxy resin (A) is contained as an essential component, and a conventional epoxy resin crosslinking agent can be blended. Further, a cationic polymerization initiator, an antioxidant or an ultra violet ray absorbing agent can be blended.

As a crosslinking agent (B), various public known compounds can be used. For example, organic amine compound, dicyandiamide and derivatives thereof, imidazole such as 2-methylimidazole, 2-ethyl-4-methyl imidazole and derivatives thereof, bisphenol A, bisphenol F, brominated bisphenol A, naphthalenediol, divalent phenol compound such as 4,4′-biphenol, novolac resin or aralkyl phenol resin obtained by condensation reaction of phenol or naphthols with formaldehyde or xylilene glycols, acid anhydride compounds such as succinic acid anhydride, maleic acid anhydride, phthalic acid anhydride, hexahyrophthalic acid anhydride, methyl hexahyrophthalic acid anhydride, nadic acid anhydride, hydrogenated nadic acid anhydride, trimellitic acid anhydride or pyromellitic acid anhydride or hydrazide compounds such as hydrazide adipate can be used and two or more kinds of these compounds can be used together with if necessary. Among these compounds, acid anhydride compounds can be desirably used, more desirably, hexahyrophthalic acid anhydride can be used. By use of said hexahyrophthalic acid anhydride, epoxy resin composition characterized that shrinkage by curing is small, having transparency, excellent in weather resistance and yellowish color change is small can be obtained.

As a curing accelerator, various public known compounds can be used. For example, tertiary amine and salts thereof, imidazoles and salts thereof, organic phosphine compound (contains organic phosphines and salts thereof), organic metal salt such as zinc octylate or tin octylate can be mentioned, and two or more kinds of these compounds can be used together with if necessary. The desirable curing accelerator is a tertiary amine and salts thereof and an organic phosphine compound, in particular, an organic phosphine compound is more desirable from the view point that coloring of cured product can be protected by use of said compound.

As other additives, antioxidant, ultra violet ray absorbing agent and other fillers, tarnishing agent, dye, parting agent, flow control agent, flame retardant, rubber reforming agent, surfactant, reactive diluent, various kinds of oligomer or various kinds of polymer can be mentioned, and two or more kinds of these compounds can be used together with if necessary. Especially, the epoxy resin composition for photo semi-conductor of this invention is desirable to blend an antioxidant so as to prevent oxidation degradation and to form a cured product of less coloration.

As an antioxidant, various kinds of compounds can be used. For example, mono phenols such as 2,6-di-tert-butyl-p-cresol, 2,6-di-tert-butyl-4-ethylphenol, butylated hydroxyl anisole, stearyl-β-(3,5-di-tert-butyl-4-4-hydroxyphenyl)propionate, bisphenols such as 2,2-methylenebis (4-methyl-6-tert-butylphenol), 2,2-methylenebis(4-ethyl-6-tert-butylphenol), 4,4′-thiobis(3-methyl-6-tert-butylphenol), polymer phenols such as 1,1,3-tris(2-methyl-4-hydroxy-5-tert-butylphenylbutane, 1,3,5-trimethyl-2,4,6-tris(3,5-di-tert-butyl-4-hydroxybenzyl)benzene, tetrakis[methylene-3-(3,5-di-tert-butyl-4-hydroxybenzyl)propionate]methane, oxaphosphaphenanthrene oxides such as 9,10-dihydro-9-oxa-10-phosphaphenanthrene-10-oxide, 10-(3,5-di-tert-butyl-4-hydroxybenzyl)-9,10-dihydro-9-oxa-10-phosphaphenanthrene-10-oxide, 10-desiloxy-9,10-dihydro-9-oxa-10-phosphaphenanthrene-10-oxide can be mentioned. Two or more kinds of these compounds can be used together with if necessary.

### EXAMPLES

The present invention will be illustrated more in detail according to Examples, however, not intending to limit the scope of claims of the present invention to Examples.

### Synthesize Example 1

Mixture of 215 parts of RIKACID MH (methylhexahydrophthalic acid anhydride, product of New Japan Chemical Co., Ltd.) and 192 parts of RIKABINOL HB (hydrogenated BPA, product of New Japan Chemical Co., Ltd.) is poured into a reactor having a stirrer, a thermometer, a nitrogen gas blowing tube and a condenser and reacts under nitrogen gas atmosphere with stirring at 250° C. for 2 hours, and end carboxyl polyester component that is solid at ordinary temperature, whose carboxyl group number per one molecular is 1.6 and carboxyl group equivalent is 320 g/eq, is obtained. Then, 507 parts of YDC-1312 (diglycidylether of 2,5-di-tert-butyl-1,4-phenylenebis; product of Tohto Kasei Co., Ltd., epoxy equivalent; 178 g/eq, melting point; 142° C.) and 0.2 weight parts of triphenylphosphate are added and is stirred and mixed at 150° C. for 4 hours. Solid epoxy resin c-1 whose softening point is 94° C., epoxy equivalent is 580 g/eq and aromatic ring containing ratio is 13.8%, is obtained.

### Synthesize Example 2

Same processes as Synthesize Example 1 are carried out except changing RIKABINOL HB to 243 parts of SPIRO GLYCOL (product of Nippon Fine Chemical Co., Ltd.), and end carboxyl polyester component that is solid at ordinary temperature, whose carboxyl group number per one molecular is 1.6 and carboxyl group equivalent is 360 g/eq, is obtained. Then, 450 parts of Y-128 (diglycidylether of 2,2-bis(4-hydroxyphenyl) propane; product of Tohto Kasei Co., Ltd., epoxy equivalent; 187 g/eq, viscosity; 13000 mps·s/25° C.) and 0.1 weight parts of triphenylphosphate are added and is stirred and mixed at 150° C. for 4 hours. Solid epoxy resin c-2 whose softening point is 92° C., epoxy equivalent is 820 g/eq and aromatic ring containing ratio is 23.1%, is obtained.

### Examples 1-2, and Comparative Examples 1-2

Epoxy resin c-1 obtained by Synthesize Example 1, Epoxy resin c-2 obtained by Synthesize Example 2, YD-012 (bisphenol A solid epoxy resin, epoxy equivalent; 645 g/eq, softening point; 81° C., aromatic ring containing ratio; 51.2%, product of Tohto Kasei Co., Ltd.) and EHPE 3150 (alycyclic backbone epoxy resin, epoxy equivalent; 180 g/eq, softening point; 78° C., aromatic ring containing ratio; 0%, product of Daicel Chemical Industries, Ltd.) are used. As a curing agent, RIKACID MH-700 (methyl hexahyrophthalic acid anhydride, acid anhydride equivalent 168 g/eq, Product of New Japan Chemical Co., Ltd.) is used and as a curing accelerator, HISHICOHLIN PX-4ET (organic phosphonium salt compound; product of Nippon Chemical Industrial Co., Ltd.) is used, and according to blending ratio shown in Tablet, epoxy resin compositions are obtained. Numerical numbers shown in Table indicate weight parts at blending process.

Cured product specimens are prepared by using these epoxy resin compositions, molded at 100° C. for 2 hours and post curing is carried out at 140° C. for 12 hours. Physical properties of the obtained specimens are measured. Results are summarized in Table 2.

Test method and evaluation method for cured products are follows.
(1) Glass transition point and dynamic viscoelasticity are measured by DMA.
(2) Water absorption ratio is measured according to following method. That is, a circular test piece of 50 mm diameter and 5 mm thickness is prepared, and the test piece is stood in 23° C. and 100% RH atmosphere for 50 hours, and weight increase ratio is measured.
(3) Coloring heat resistance is measured by observing color change of a test piece of 10 mm diameter and 5 mm thickness.
(4) Cracking causing ratio is measured according to following method.

That is, prepare a test piece of 10 mm diameter and 5 mm thickness in which a LED element is sealed, and heat cycle test of −20° C.(30 min.)→120° C. (15 min.)→20° C. (30 min.) is repeated 5 times on the test piece, and numbers of test pieces that causes cracks among 10 test pieces are counted.

TABLE 1

| | Aromatic | | | | |
|---|---|---|---|---|---|
| | ring | | | | |
| | containing | | | Comp. | Comp. |
| | ratio | Example 1 | Example 2 | Example 1 | Example 2 |
| Epoxy resin | 13.8 | 100 | — | — | — |
| c-1 | | | | | |
| Epoxy resin | 23.1 | — | 100 | — | — |
| c-2 | | | | | |
| YD-012 | 51.2 | — | — | 100 | — |
| EHPE3150 | 0 | — | — | — | 100 |
| Crosslinking | | 26.1 | 18.4 | 23.4 | 84.0 |
| agent | | | | | |
| Curing | | 0.5 | 0.5 | 0.5 | 0.5 |
| accelerator | | | | | |

TABLE 2

| | | | Comp. | Comp. |
|---|---|---|---|---|
| | Exam- | Exam- | Exam- | Exam- |
| | ple 1 | ple 2 | ple 1 | ple 2 |
| Cured product Tg (° C.) | 152 | 130 | 110 | 223 |
| Dynamic viscoelasticity | 8.0 | 6.5 | 15 | 250 |
| (250° C.; MPa) | | | | |
| Water absorption ratio (%) | 1.0 | 1.2 | 2.1 | 1.5 |
| Coloring heat resistance *¹ | | | | |
| (150° C. × 72 hr) | ◯ | ◯ | X | ◯ |
| (135° C. × 72 hr) | ◯ | ◯ | Δ | ◯ |
| (120° C. × 72 hr) | ◯ | ◯ | ◯ | ◯ |
| Cracking causing ratio | 0/10 | 0/10 | 7/10 | 10/10 |

*¹ ◯ no yellowish change
Δ slightly changed to yellow
X yellowish change

As clearly understood from above mentioned Examples, epoxy resin compositions to which epoxy resin (A) of the present invention is blended, provides a cured product being excellent in transparency, high Tg, low water absorption ratio and low elasticity in rubber sphere. Therefore, the epoxy resin composition is useful for the field of electron material such as photo semi conductor sealing material that requires heat resistance, humid resistance and cracking resistance, and in particular, useful as an epoxy resin composition for LED sealing.

### INDUSTRIAL APPLICABILITY

The epoxy resin composition of this invention is superior in heat resistance, humid resistance and cracking resistance, therefore, is useful for the field of electron material such as photo semi conductor sealing material, in particular, useful as an epoxy resin composition for LED sealing.

1. An epoxy resin composition comprising, containing a solid epoxy resin (A) whose aromatic ring containing ratio is 5-40% obtained by reacting a polyester compound (b) possessing 1.2-1.8 of carboxylic group per one molecular obtained by reaction of 1.2-1.8 moles of divalent carboxylic acid or acid anhydride thereof to 1 mol of divalent alcohol with a divalent epoxy resin (a) whose epoxy equivalent is 120-350 g/eq and a crosslinking agent (B) as essential components.

2. The epoxy resin composition of claim 1, wherein the divalent epoxy resin (a) whose epoxy equivalent is 120-350 g/eq, is at least one selected from the group consisting of 2,5-di-tert-butyl-1,4-phenylenebis glycidylether and 2-bis(4-hydroxyphenyl)propanediglycidylether.

3. The epoxy resin composition of claim 1, wherein epoxy equivalent of the solid epoxy resin (A) is 300-1000 g/eq and softening point of the solid epoxy resin (A) is 60-120° C.

4. A cured product obtained by curing epoxy resin compositions according to claim 1.
